(19) United States
(12) Patent Application Publication
(10) Pub. No.: US 2015/0324996 A1
(43) Pub. Date: Nov. 12, 2015

(54) IMAGE PROCESSING FOR PRINTING

(71) Applicants: Peter MOROVIC, San Cugat Del Valles (ES); Jan MOROVIC, Colchester (GB); Marti Rius ROSSELL, Sant Cugat Del Valles (ES); Juan Manuel Garcia Reyero VINAS, Sant Cugat Del Valles (ES); HEWLETT-PACKARD DEVELOPMENT COMPANY, L P, Houston, TX (US)

(72) Inventors: Marti Rius Rossell, Sant Cugat del Valles (ES); Peter Morovic, Sant Cugat del Valles (ES); Jan Morovic, Colchester (GB); Juan Manuel Garcia Reyero Vinas, Sant Cugat del Valles (ES)

(21) Appl. No.: 14/762,802

(22) PCT Filed: Jan. 29, 2013
(86) PCT No.: PCT/EP2013/051617

§ 371 Date: Jul. 22, 2015

(51) Int. Cl. G06T 7/00; G06T 7/40; G06K 9/46; H04N 1/60

(52) U.S. Cl. CPC G06T 7/0081; H04N 1/6072; G06T 7/408; G06K 9/4652; H04N 1/6027

(57) ABSTRACT

Image processing for printing comprises identifying regions of an input image having characteristics of distinct printing requirements; classifying each pixel within each identified region based on the characteristic of the identified region; applying a colour mapping to each pixel according to the classification of the pixel to optimize each color mapping in accordance with at least one of plurality of attributes.

### BACKGROUND

All printers implement some data transformation that converts pixels in sRGB (or in any other color space) to drops on paper, and ultimately to printed objects of a given colorimetry. This transformation is done following a set of requirements intended to provide the desired image quality, printing speed or any other attribute.

A typical challenge for this data pipeline is that requirements may be different for different areas of the image, or that requirements may be different for different status of the printer. Being able to distinctly handle different parts of the image without tradeoffs can be a decisive advantage for highly demanding printing environments such as Page Wide Array (PWAx) printing systems.

### BRIEF DESCRIPTION OF DRAWINGS

For a more complete understanding, reference is now made to the following description taken in conjunction with the accompanying drawings in which:

FIG. 1 is a schematic diagram of a print system, according to one example;

FIG. 2 is a flow chart of a printing process using a color separation table, according to one example;

FIG. 3 is a flowchart of the processing of step 210 of FIG. 2 in more detail, according to one example;

FIG. 4 is an illustration of the stages of the processing of FIG. 3, according to one example.

### DETAILED DESCRIPTION

One example of identifying and handling image areas in a distinct way is applying distinct processing only at the halftone and/or masking stages. Examples are K-fortification, distinct handling of mask levels, e.g. Thernal Inkjet (TIJ), and multiple halftone screens, e.g for use in (dry toner) laser printing or LEP printing (e.g. Indigo presses). A first limitation of this approach is the risk of patterning or color differences induced by the different algorithms. A second limitation is the inability to smoothly transition between areas with different treatments. In practice, those limitations have restricted their application to insensitive colors (typically K areas) or to different image objects not intended to be placed side by side. Another problem of the current approaches is their limited ability to optimize attributes for different colors. Finally, the range of problems that can be addressed by halftone or masks is limited. Another example is bidirectional color maps which aim at keeping colorimetry between areas of the image, but do not attempt at optimizing attributes.

Halftone Area Neugebauer Separation (HANS) pipeline provides possibilities on how different parts of the image may be optimized. For the present invention different areas of the image are identified and processed with color separations designed to have specific attributes but with the same colorimetry. The range of problems that can be addressed is large, it can be applied with much greater flexibility and the separations are transitionable.

One of the problems that could be solved with the current approach is fortification and depletion algorithms which are examples of how different areas of an image can be handled. These algorithms aim at modifying the number of drops fired in certain image areas. Typically, they determine the inner portions of area fills, and add ink (K-fortification) or remove it (depletion), depending on the design goal. Another problem is Halftone algorithms in which printers optimize their halftone pattern according to the object type. Another problem is bidirectional colormaps in which different colormaps are applied to forward/reverse passes to compensate the effect of hue shift caused by different drop landing. Yet another example is governed print modes in which printers change their operation conditions (typically, on number of passes or carriage speed) as a function of image content or printer status. For example, text may be printed faster than area fills, or carriage speed may be reduced if the printhead approaches its thermal limits. Another example is distinction via halftone levels and different mask levels in which a common approach is to distinguish pure K text, lines and area fills via a dedicated halftone level (usually named SpecialK). Then, the masks are designed to handle such areas in a different way.

This disclosure describes various exemplary methods and computer products for printing a document in a printing system. In particular, this disclosure describes selecting certain Neugebauer Primaries (NPs) and Neugebauer Primary area coverages (NPacs) to optimize a printing process according to a certain print attribute.

In one example, the Neugebauer Primaries are the possible combinations of a set of n inks. Each ink within the set may be at one of k levels for a single halftone pixel, where there are kⁿ combinations for each ink set defining all of the possible ink configuration states that a single halftone pixel can have. For example, where k=2 for a binary (or bi-level) printer, the printer is able to use either no ink or one drop of ink at a single pixel per ink channel. For example, where n=2 the printer would have two ink channels, for example C and M. The possible combinations would then be White (W), C, M and CM, being kn=2²=4 possible combinations. For example, for a printer comprising six different inks and the ability to place either 0, 1, or 2 drops of each ink at each halftone pixel, resulting in 3⁶ or 729 NPs. A certain color may correspond to a certain NPac, which may be represented as a vector, wherein [W, C, M, CM]=[a(area)_{W} %, a_{C} %' a_{M} %, a_{CM} %], where a_{W} %+a_{C} %+a_{M} %+a_{CM} %=100%.

NPacs may be represented by linear, convex combinations of NPs, wherein the relative area coverages over a unit area are the convex weights. An NPac may also represent a single NP, that NP having a 100% area coverage weight and the other NPs being at 0%. According to an example in this disclosure, all of a printing system's NPacs are accessible, so the full color gamut of a printing system can be addressed.

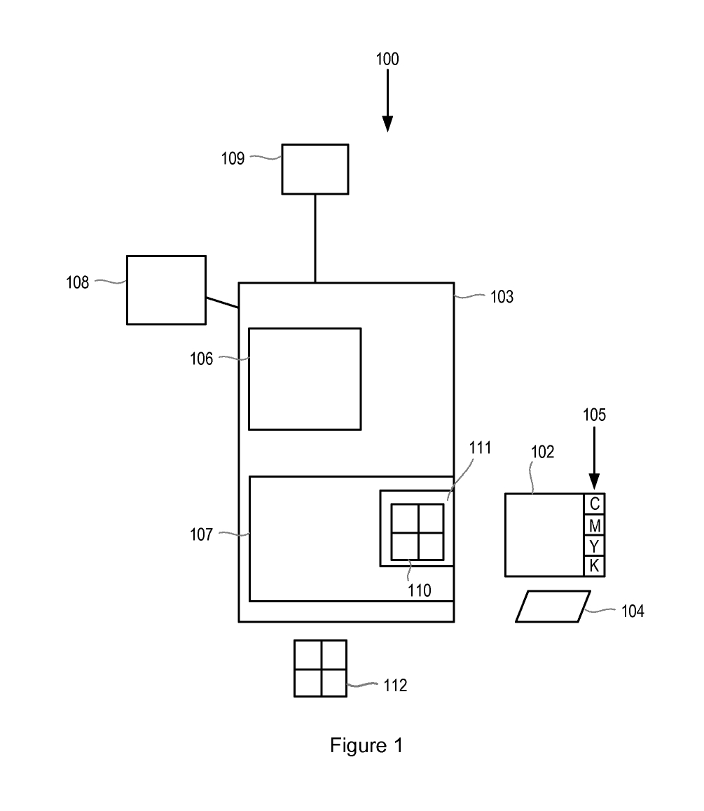

FIG. 1 illustrates an example of a printing system 100. The print system 100 may comprise a printer 102 of a predetermined type. Without intending to limit to a specific type of printer 102, the printer 102 may comprise a large or small format printer, a laser printer, an inkjet printer, an offset printer, a digital press, a dot-matrix printer, a line printer, and/or a solid ink printer.

The printing system 100 can be driven, at least in part, by one or more suitable computing devices 103. Computing devices 103 that may be used include, but are not limited to, a personal computer, a laptop computer, a desktop computer, a digital camera, a personal digital assistance device, a cellular phone, a video player, and other types of image sources.

The printer 102 may comprise a print head arranged to print on a substrate 104. The substrate 104 may comprise any type of substrate, for example, but not limited to, paper, films, foils, textiles, fabrics, or plastics. The printer 102 may comprise, or be connected to, a certain ink set 105. The ink set 105 may comprise a predetermined number of inks, for example four inks which may be Cyan, Magenta, Yellow and Black (CMYK). The ink set 105 may be determined by the printer 102, wherein different printers 102 correspond to different ink sets 105, or different ink sets 105 may be applied in one printer 102.

The computing device 103 may be physically integrated with or connected to the print system 100. The computing device 103 may be arranged to process image data. The computing device 103 may be arranged to separate and/or convert colors. The computing device 103 may comprise a processing circuit 106 and a storage device 107. The storage device 107 may facilitate any type of computer data storage. The storage device 107 may comprise, but should not be limited to, any type non-volatile memory such as a hard disk, a solid state storage device, a ROM (Read Only Memory), an exchangeable data carrier, etc. The storage device 107 may store data, drivers, and computer programs, amongst others. The processing circuit 106 may include an identifier. The identifier may be software or hardware or a combination of software and hardware configured to identify regions of an input image having characteristic of distinct printing requirements. The processing circuit 106 may further include a classifier. The classifier may be software or hardware or a combination of software and hardware configured to classify each pixel within each identified region based on the characteristic of the indentified region. The processing circuit 106 may further include a colour mapper. The color mapper may be software or hardware or a combination of software and hardware configured to colour map each pixel according to the classification of the pixel.

For example, an image for printing may be retrieved from the storage device 107, a remote storage location 108, such as an online application, using the Internet, and/or a local area network. Furthermore, a graphical user interface 109 may be provided for allowing an operator to change or interact with the print system 100.

In an example, a color separation that is performed in the printer pipeline may be optimized for a certain print attribute. The print attribute may comprise minimum ink usage. A color look-up table (or color separation table) 110 may be provided, comprising NPacs paired with certain color values. The color separation table 110 may be stored in a print system driver, for example a printer driver 111. The storage device 107 may store the table 110. The table 110 may be stored in software running on the computing device 103, and/or on a remote storage location 108. In this description, amongst others, a method of setting up such table 110 will be described, wherein second NP area coverages may be incorporated, that may be obtained from a predetermined halftone data chart 112 containing predetermined pairs of halftone data and corresponding color values that are optimal for a certain print system 100.

Certain features of the print system 100 may influence an outgoing image color for a given color input value, for example an input RGB value. For example, a specific ink set 105, and/or substrate 104 may influence the actual printed color. Therefore, the color separation table 110 and the predetermined halftone data chart 112 may apply to a specific print system 100, for example for a specific combination of a printer 102, ink set 105 and/or substrate 104.

The printing system 1 may employ a color separation interface and image processing system referred to as Halftone Area Neugebauer Separation (HANS).

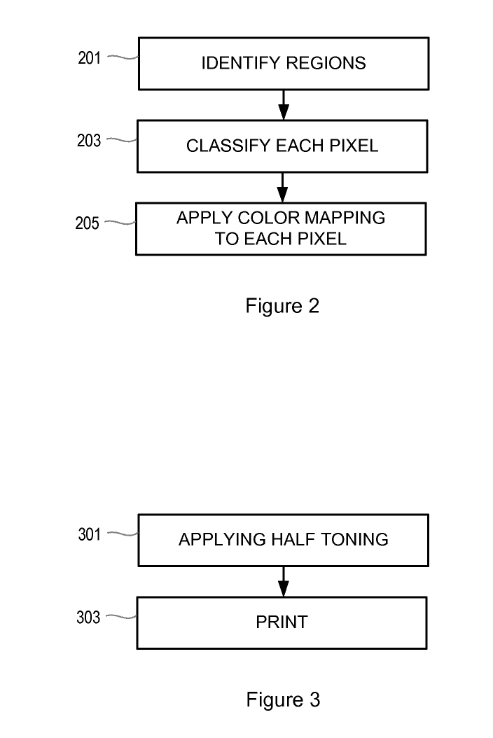

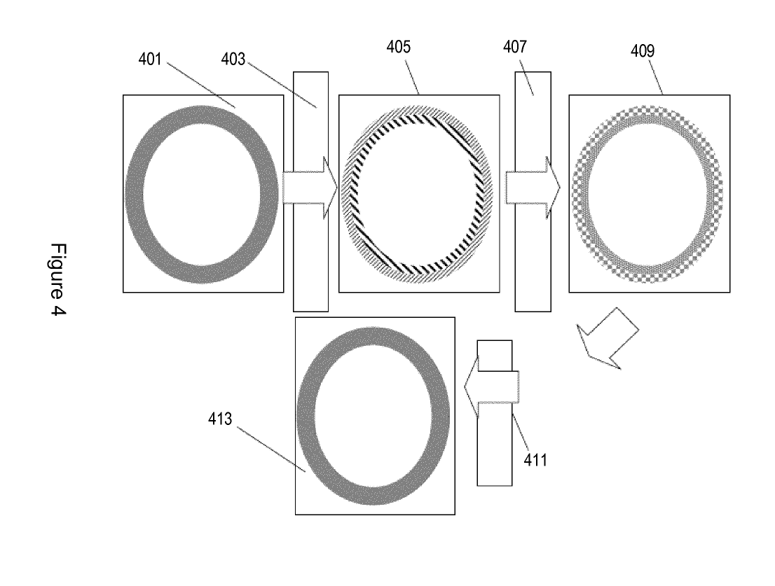

FIG. 2 illustrates image processing of an example of the invention. An input image may be provided to the processing circuit 106 of the print system 100. For example the image may be received through a network or a data carrier. The input image comprises a plurality of pixels. It is processed by the print system 1 by identifying, 201, regions of an input image having characteristics of distinct printing requirements; classifying, 203, each pixel within each identified region based on the characteristic of the identified region; and applying, 205, a colour mapping, for example color separation, to each pixel according to the classification of the pixel to optimize each color mapping in accordance with at least one of plurality of attributes.

In an example, the step of applying the color mapping 205 may comprise receiving the device dependent RGB values of the pixel of the input image. The received RGB image may be mapped with the NPac's convex hull in the CIE XYZ color space.

The system 100 may map each of the XYZs onto an NPac. The matching NPac may be retrieved from the color separation table 110. For example, the table 110 may link NPacs to CIE XYZ values that are specific for the print system 100, i.e. printer 102, ink set 105 and/or substrate 104. A part of the NPacs may have been converted from halftone data that was obtained from the chart 112, wherein the respective corresponding color values may for example have comprised CIE XYZ, or may have been converted from another color value to CIE XYZ.

The respective NPacs in the table 110 are selected based on the classification of the pixel of an identified region so that the respective NPac is optimized for minimal ink usage and/or other print attributes such as, but not limited to, smooth transitions between colors, low cost per copy, color constancy against drop misplacement, drop size changes and/or perceived grain.

Other attributes that could be optimized are the robustness against the image quality artifact known as “decap”. Decap may arise because nozzles that have not fired for a certain amount of time need a number of firing events before recovering. The expression “firing event” refers herein to the action of one particular nozzle that fires or tries to fire a drop of ink during a firing step.

If a nozzle fires a drop of ink every M firing steps, and if it takes DR firing events to recover a nozzle from e. g. a viscous plug, then the length of the print medium affected by decap is approximately:

Decap length=M×DR

The lower is M (that is, the higher is the firing frequency of a nozzle) the smaller is the decap length for this nozzle, because the nozzle recovers from decap earlier. A color separation may be designed to be more robust to decap by selecting those npacs that tend to concentrate the firing of drops of a given ink channel onto a subset of nozzles. Such operation makes those prioritized nozzles fire more ink than their non-prioritized neighbors, thus printing at higher average rate and reducing the effective value of M, and consequently the Decap length where the artifact can be detected.

Another scenario where a separation could be prioritized is in the context of intraprinthead bubble formation problems. This phenomena occurs when ink is unintentionally heated inside the printhead. In such cases, air dissolved in ink tends to dissociate and become free are, thus creating air bubbles, which in turn may block ink channels or nozzle chambers. The effect gets more severe on unused nozzles or ink channels, since the lack of cold, fresh ink accentuates the effect and prevents the air from dissolving again. A separation could be tuned to compensate for this effect by selecting npacs whose coefficients induce a continuous usage of small quantities of the ink channels that may suffer from this effect at a given area of a printed image.

Furthermore, it may also be desirable to pseudo-randomly fire nozzles that have not been used, to refresh the ink contained in them, and to prevent the formation of viscous plugs. Such firing occurs on empty (white) areas on the media, and it is done in such a way that the small quantity of drops deposited on media is not easily perceivable by the human eye. This strategy is well-known in the industry, but the ability to activate it from the color separation stage, and with different parameters according to the characteristics of different regions, adds more versatility to the solution it provides. For example, such pseudo-random firing could refresh only those nozzles needed in short. This would be done by selecting the adequate Npacs close to the white point that fire the desired nozzles while keeping the appearance of white. That could be of help in PWAx systems to reduce need to interrupt printing to go to the spittoon.

The NPacs are retrieved from the color separation table 110. The retrieved NPacs are then communicated to a halftoning process and applied, 301. Halftoning may be used to define a spatial arrangement of the NPs specified in the input NPac vectors. For example, Vector Error Diffusion or Device State Error Diffusion (DSED) may be applied as a halftoning technique, wherein the NPs are its states and the error is diffused in the NPac space. The input image is then printed, 303, as a hard copy on the substrate 104.

With reference to FIG. 4, in an implementation, the processing circuit 106 runs an algorithm 403 that distinguishes regions of an input image 401 that require different handling. Each pixel is classified and tagged with its class adscription, which results in a second image 403. As an example, algorithm 403 may distinguish the borders of area fills that might be affected by Decap.

A color separation pipeline 407 handles pixels according to their tag. Color separations for each pixel class are optimized according to different metrics. They are also designed to have the same colorimetry. The separation 407 may also determine transition areas between different pixel classes. A third image 409 is produced.

The optimization of each color mapping in accordance with at least one of a plurality of attributes is carried out for each of the separations. In one example, the optimization is carried out in an analytical way. For example, to increase robustness against decap, NPacs are selected so that, for carefully chosen subsequent halftone and mask stages, some nozzles are prioritized for firing events. In an alternative example, the optimization is based on statistics of the halftoned images. For example, it may be desirable to optimize a given skin tone to show less grain, the Npac is selected for which statistics related to graininess are minimized (using statistical techniques used in image processing). Or, it may be desirable to use as little ink as possible, the Npac may then be selected for the colour mapping that achieves the required colorimetry using the fewest ink drops.

As an example, the border of an area fill could be color separated to be robust against Decap, whereas the inner portion could be processed to be robust against changes in Drop Weight.

A printer backend 411 prints the output 409 of pipeline 407, and generates a fourth image 413 on a substrate, where no noticeable differences are seen between image parts, and for which each image area has been optimized for the most favourable attribute.

Further distinction via halftone levels and/or different mask levels (such as K-fortification or Depletion algorithms), which work for some artifacts such a line roughness, can still be utilised.

Attributes of the pixels can be optimized depending on the object type (e.g. less grain for photos, more robustness for solid area fills).

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. The features of any dependent claim may be combined with the features of any of the independent claims or other dependent claims.

1. A method of processing an image for printing, the method comprising the steps of:
identifying regions of an input image, the input image comprising a plurality of pixels, having characteristics of distinct printing requirements;
classifying each pixel within each identified region based on the characteristic of the identified region; and
applying a colour mapping to each pixel according to the classification of the pixel to optimize each color mapping in accordance with at least one of a plurality of attributes.

2. A method according to claim 1, wherein the characteristic of the printing requirement comprises of at least one of: in-fills, lines, text, borders, photographs, patterns, information relating to the status of a printer, or parts thereof, being used to print the processed image.

3. A method according to claim 1, wherein characteristics of distinct printing requirements comprises at least one of decap, bubble-formation, line quality, pseudo-random firing, ink usage, drop volume changes.

4. A method according to claim 1, wherein the step of applying a colour mapping comprises
looking up a colour value in a colour separation table and applying the colour value to each pixel.

5. A method according to claim 1, wherein the step of classifying each pixel comprises
tagging each pixel with an attribute value.

6. A method according to claim 1, the method further comprising applying a halftoning to each colour mapped pixel.

7. A method of printing, the method comprising the steps of:
processing an input image according to claim 1; and
printing the processed image.

8. Apparatus for processing an input image for printing, the apparatus comprising:
an identifier component configured to identify regions of an input image having characteristic of distinct printing requirements;
a classifier component configured to classify each pixel within each identified region based on the characteristic of the indentified region; and
a colour mapper component configured to colour map each pixel according to the classification of the pixel to optimize each color mapping in accordance with at least one of plurality of attributes.

9. Apparatus according to claim 9, wherein the apparatus further includes a color look up table configured to enable a colour value to be selected from the color look up table according to the classification of each pixel and applying the colour value to the pixel.

10. Apparatus according to claim 10, the apparatus further comprising a halftoner configured to apply a halftoning process to the processed image.

11. One or more computer-readable storage media comprising instructions stored thereon, the when executed, direct a processor to perform a method comprising:
identifying regions of an input image, the input image comprising a plurality of pixels, having characteristics of distinct printing requirements;
classifying each pixel within each identified region based on the characteristic of the identified region; and
applying a colour mapping to each pixel according to the classification of the pixel to optimize each color mapping in accordance with at least one of plurality of attributes.
